(19) United States
(12) Patent Application Publication
(10) Pub. No.: US 2015/0109895 A1
(43) Pub. Date: Apr. 23, 2015

(54) OPTICAL INFORMATION REPRODUCING APPARATUS, OPTICAL INFORMATION REPRODUCING METHOD, AND OPTICAL INFORMATION RECORDING METHOD

(71) Applicant: Hitachi-LG Data Storage, Inc., Tokyo (JP)

(72) Inventors: Kouichirou NISHIMURA, Tokyo (JP); Tatsuro IDE, Tokyo (JP)

(73) Assignee: Hitachi-LG Data Storage, Inc., Tokyo (JP)

(21) Appl. No.: 14/519,378

(22) Filed: Oct. 21, 2014

(30) Foreign Application Priority Data
Oct. 21, 2013 (JP) 2013-217991

(51) Int. Cl. G11B 7/0065; G11B 7/1353

(52) U.S. Cl. CPC G11B 7/0065; G11B 7/1353
USPC 369/103

(57) ABSTRACT

When books are densely bedded on a recording medium for recording a hologram on the medium with a high density, the books need to be positioned at a reference light irradiation position with a high precision when reproducing. An optical information reproducing apparatus for producing information from an optical information recording medium, includes: a light source that emits a reference light; an angle adjustment part that adjusts an incident angle of the reference light emitted from the light source to the optical information recording medium; a filter part that suppresses an unnecessary light of a diffracted light obtained when the optical information recording medium is irradiated with the reference light adjusted by the angle adjustment part; a light detection part that detects at least a part of the diffracted light obtained by irradiating the optical information recording medium with the reference light adjusted by the angle adjustment part; and a control part that controls the filter part, wherein at least a part of page data within an adjacent book is recorded as information on the optical information recording medium while deviating the incident angle of the reference light in an angle multiplexing direction, and wherein the control part controls the filter part on the basis of the signal detected by the light detection part.

### CROSS-REFERENCE TO RELATED APPLICATION

This application claims the Japanese Patent Application No. 2013-217991 filed Oct. 21, 2013, which is incorporated herein by reference in its entirety.

### BACKGROUND OF THE INVENTION

1. Field of the Invention

The present invention relates to a method of recording information on a recording medium with the use of holography, a device and method of reproducing the information recorded on the recording medium with the use of holography, and particularly to detection of reproduction position deviation.

2. Description of the Related Art

As a background art, there are JP-A-2006-208921 and JP-A-2009-87448. JP-A-2006-208921 discloses that “in a holography medium of the invention, position detection information indicative of a position of information data stack in which plural information data pages are recorded with different angles of the reference lights is recorded in a given information data page when writing information data”. Also, JP-A-2009-87448 discloses that “when a set of the incident angle of the reference light to a disc when recording hologram in an angular multiplexing recording system is represented by {θ}=[θ1, θ2, . . . , θM], the incident angle {θ} of the reference light is switched according to a position or a track position on an optical information recording medium”.

### SUMMARY OF THE INVENTION

When the hologram is recorded on the hologram recording medium with a high density, it is necessary that multiplex-recorded page data (hereinafter called “books”) is densely bedded on the hologram recording medium while the number of angular multiplexing page data (the number of multiplexing) increases. When the books are densely recorded on the hologram recording medium, because intervals between the adjacent books are minute, there is a need to position the books at a reference light irradiation position with high precision in reproduction from the viewpoint of preventing crosstalk.

JP-A-2006-208921 does not consider the leakage of the reproduction light from the adjacent book. Also, JP-A-2009-87448 does not consider the detection of the reproduction position deviation.

Under the circumstances, an object of the present invention is to realize a hologram recording with a large capacity, which can stably detect a reproduction position deviation in reproducing the information recorded on a hologram recording medium.

As an example, the above problem is solved by recording at least apart of the page data within the adjacent book while deviating the incident angle of the reference light in an angular multiplexing direction.

According to the present invention, the reproduction position deviation can be stably detected, and the hologram recording of a large capacity can be realized.

### BRIEF DESCRIPTION OF THE DRAWINGS

FIG. 1 is a schematic diagram illustrating page image data for detecting a reproduction positioning deviation of an optical information recording and reproducing apparatus;

FIG. 2 is a schematic diagram illustrating an optical information recording and reproducing apparatus according to an embodiment;

FIG. 3 is a schematic diagram illustrating a pickup within the optical information recording and reproducing apparatus according to the embodiment;

FIG. 4 is a schematic diagram illustrating the pickup within the optical information recording and reproducing apparatus according to the embodiment;

FIGS. 5A to 5C are flowcharts illustrating operation flows of the optical information recording and reproducing apparatus according to the embodiment;

FIG. 6 is a schematic diagram illustrating a signal generation circuit within the optical information recording and reproducing apparatus according to the embodiment;

FIG. 7 is a schematic diagram illustrating a signal processing circuit within the optical information recording and reproducing apparatus according to the embodiment;

FIGS. 8A and 8B are flowcharts illustrating operation flows of the signal generation circuit and the signal processing circuit according to the embodiment;

FIGS. 9A and 9B are schematic diagrams illustrating a polytopic filter and a circuit for detecting a reproduction position deviation of the optical information recording and reproducing apparatus;

FIG. 10 is a schematic diagram illustrating the reproduction position deviation in the optical information recording and reproducing apparatus;

FIG. 11 is a diagram illustrating a relationship between books and a reference light irradiation position on the optical information recording medium;

FIG. 12 is a diagram illustrating a relationship between page data and a reference light irradiation position on the optical information recording medium at a given reference light angle;

FIG. 13 is a schematic diagram illustrating a relationship between the reproduction position deviation and a photodetector output in the optical information recording and reproducing apparatus;

FIG. 14 is a flowchart illustrating a reproduction position control sequence in the optical information recording and reproducing apparatus;

FIG. 15 is a schematic diagram illustrating a reproduction position deviation control in the optical information recording and reproducing apparatus;

FIG. 16 is a flowchart illustrating a reproduction position control sequence in the optical information recording and reproducing apparatus;

FIGS. 17A and 17B are schematic diagrams illustrating a relationship between a book recording position and a servo page recording reference light angle in the optical information recording and reproducing apparatus;

FIG. 18 is a schematic diagram illustrating an inter-page angle arrangement in an angle-multiplexed recording of the optical information recording and reproducing apparatus;

FIGS. 19A to 19C are schematic diagrams illustrating a relationship between a book recording position and a servo page recording reference light angle in the optical information recording and reproducing apparatus;

FIG. 20 is a schematic diagram illustrating an angle selectivity of each page in the angle-multiplexed recording of the optical information recording and reproducing apparatus;

FIG. 21 is a schematic diagram illustrating an angle selectivity of each page in the angle-multiplexed recording of the optical information recording and reproducing apparatus;

FIG. 22 is a schematic diagram illustrating a recording reference light angle arrangement of a servo page in the angle-multiplexed recording of the optical information recording and reproducing apparatus;

FIG. 23 is a schematic diagram illustrating a recording reference light angle arrangement of a servo page in the angle-multiplexed recording of the optical information recording and reproducing apparatus;

FIG. 24 is a schematic diagram illustrating a recording reference light angle arrangement of a servo page in the angle-multiplexed recording of the optical information recording and reproducing apparatus; and

FIGS. 25A and 25B are a schematic diagrams illustrating a recording reference light angle arrangement of a servo page in the angle-multiplexed recording of the optical information recording and reproducing apparatus.

### DETAILED DESCRIPTION OF THE INVENTION

Hereinafter, embodiments of the present invention will be described with reference to the accompanying drawings.

### First Embodiment

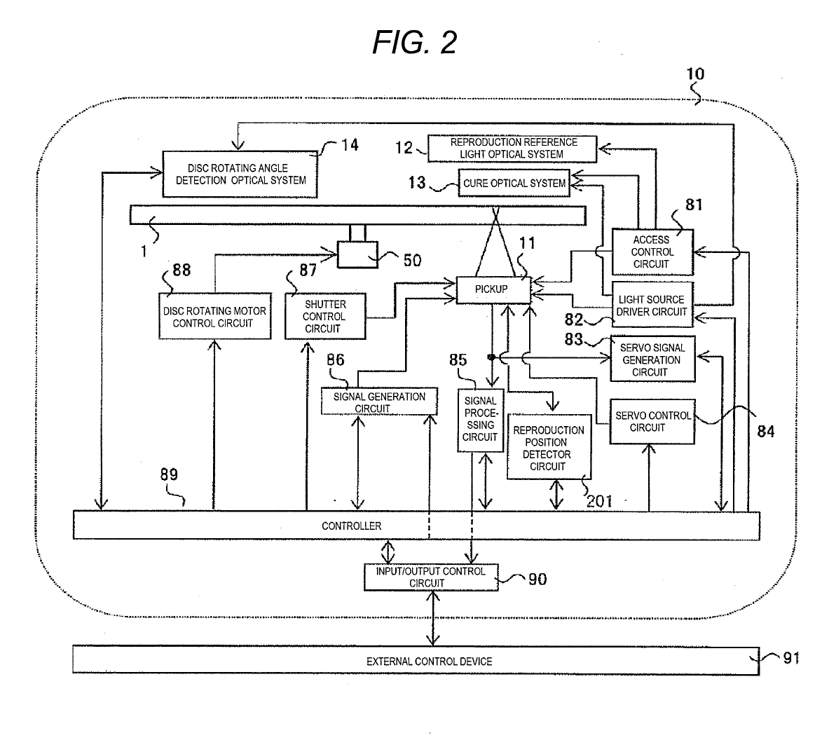

Embodiments of the present invention will be described with reference to the accompanying drawings. FIG. 2 is a block diagram illustrating a recording and reproducing apparatus of an optical information recording medium for recording and/or reproducing digital information with the use of a holography.

An optical information recording and reproducing apparatus 10 is connected to an external control device 91 through an input/output control circuit 90. In recording, the optical information recording and reproducing apparatus 10 receives an information signal to be recorded from the external control device 91 through the input/output control circuit 90. In reproduction, the optical information recording and reproducing apparatus 10 transmits the reproduced information signal to the external control device 91 through the input/output control circuit 90.

The optical information recording and reproducing apparatus 10 includes a pickup 11, a reproduction reference light optical system 12, a cure optical system 13, a disc rotating angle detection optical system 14, and a rotating motor 50. An optical information recording medium 1 is rotatable by the rotating motor 50.

The pickup 11 functions to irradiate the optical information recording medium 1 with a reference light and a signal light to record digital information on a recording medium with the use of a holography. In this situation, the information signal to be recorded is transmitted to a spatial light modulator within the pickup 11 through a signal generation circuit 86 by a controller 89, and the signal light is modulated by the spatial light modulator.

In reproducing information recorded on the optical information recording medium 1, a light wave allowing the reference light emitted from the pickup 11 to be input to the optical information recording medium in a direction opposite to that when recording is generated by the reproduction reference light optical system 12. A reproduction light reproduced by a reproduction reference light is detected by a photodetector to be described later within the pickup 11, and the signal is reproduced by a signal processing circuit 85.

An irradiation time of the reference light and the signal light with which the optical information recording medium 1 is irradiated can be adjusted by controlling an open/close time of a shutter within the pickup 11 by the controller 89 through a shutter control circuit 87.

The cure optical system 13 functions to generate an optical beam used for a precure and a postcure of the optical information recording medium 1. The precure is a previous process in which, in recording information at a desired position within the optical information recording medium 1, the recording medium is irradiated with a given optical beam at a desired position in advance before the recording medium is irradiated with the reference light and the signal light at the desired position. The postcure is a post-process in which after the information has been recorded at the desired position within the optical information recording medium 1, the recording medium is irradiated with the given optical beam at the desired position for the purpose of making the position unrecordable.

A disc rotating angle detection optical system 14 is used for detecting a rotating angle of the optical information recording medium 1. When the optical information recording medium 1 is adjusted to a given rotating angle, a signal corresponding to the rotating angle is detected by the disc rotating angle detection optical system 14, and the rotating angle of the optical information recording medium 1 can be controlled by the controller 89 through a disc rotating motor control circuit 88 with the use of the detected signal.

A given light source drive current is supplied to light sources within the pickup 11, the cure optical system 13, and the disc rotating angle detection optical system 14 from a light source driver circuit 82, and optical beams can be emitted from the respective light sources with given light intensities.

Also, the pickup 11 and the cure optical system 13 are each equipped with a mechanism in which the position can be slid in a radial direction of the optical information recording medium 1, and a position control is conducted through an access control circuit 81.

Incidentally, a recording technique using a principle of angular multiplexing of the holography has a tendency for a permissible error to a deviation of the reference light angle to become extremely small.

Therefore, it is necessary that a mechanism for detecting the amount of deviation of the reference light angle is installed within the pickup 11, a servo control signal is generated by a servo signal generation circuit 83, and a servo mechanism for correcting the amount of deviation through a servo control circuit 84 is installed within the optical information recording and reproducing apparatus 10. Also, the pickup 11, the cure optical system 13, and the disc rotating angle detection optical system 14 may be simplified by bringing several optical system configurations or all of the optical system configurations together.

A reproduction position detector circuit 201 is configured to detect a reproduction position deviation on the basis of a signal obtained by the pickup 11. The detected reproduction position deviation information is input to the controller 89, and control information necessary for the servo control circuit 84, the access control circuit 81, and so on is expanded.

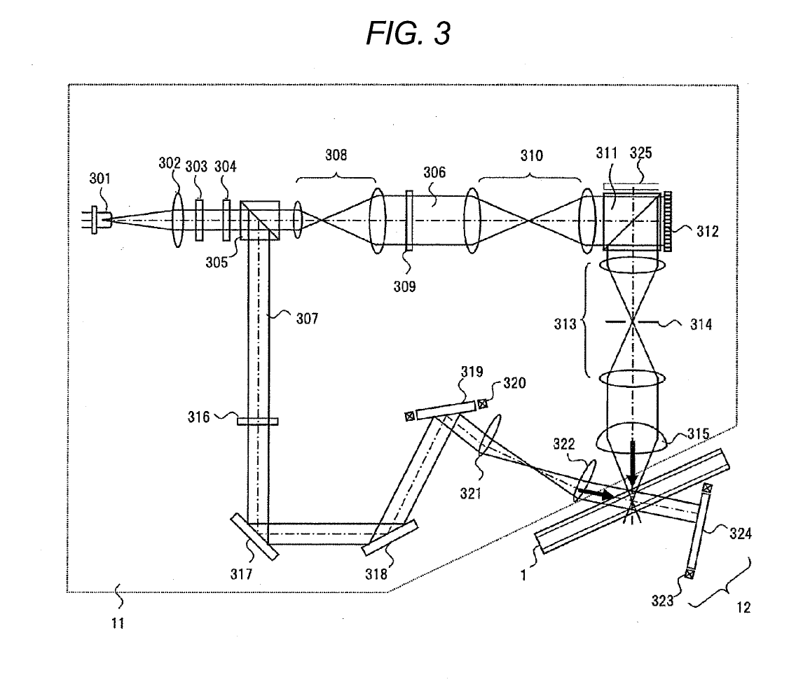

FIG. 3 illustrates a recording principle in an example of a basic optical system configuration of the pickup 11 in the optical information recording and reproducing apparatus 10. An optical beam emitted from a light source 301 is transmitted through a collimator lens 302, and input to a shutter 303. When the shutter 303 is opened, after the optical beam has passed through the shutter 303, a polarization direction is controlled by an optical element 304 formed of, for example, a half-wavelength plate, so that a light intensity ratio of a p-polarized light and an s-polarized light becomes a desired ratio. Thereafter, the optical beam is input to a PBS (polarization beam splitter) prism 305.

The optical beam that has been transmitted through the PBS prism 305 serves as a signal light 306, and an optical beam diameter is expanded by a beam expander 308. Thereafter, the optical beam is transmitted through a phase mask 309, a relay lens 310, and a PBS prism 311, and input to a spatial light modulator 312.

The signal light added with information by the spatial light modulator 312 is reflected from the PBS prism 311, and propagates through a relay lens 313 and a polytopic filter 314. Thereafter, the signal light is converged on the optical information recording medium 1 by an objective lens 315.

On the other hand, the optical beam reflected from the PBS prism 305 serves as a reference light 307, and set to a given polarizing direction according to a recording time or a reproduction time by a polarizing direction conversion element 316. Thereafter, the optical beam is input to a galvanometer mirror 319 through a mirror 317 and a mirror 318. Because the galvanometer mirror 319 can be adjusted in angle by an actuator 320, an incident angle of the reference light input to the optical information recording medium 1 after having passed through a lens 321 and a lens 322 can be set to a desired angle. In order to set an incident angle of the reference light, the galvanometer mirror may be replaced with an element that converts a wave surface of the reference light.

As described above, the signal light and the reference light are input to the optical information recording medium 1 so as to be superimposed on each other, to thereby form an interference fringe pattern within the recording medium. The pattern is written to the recording medium to record information. Also, because the incident angle of the reference light input to the optical information recording medium 1 can be changed by the galvanometer mirror 319, an angular multiplexing recording is enabled.

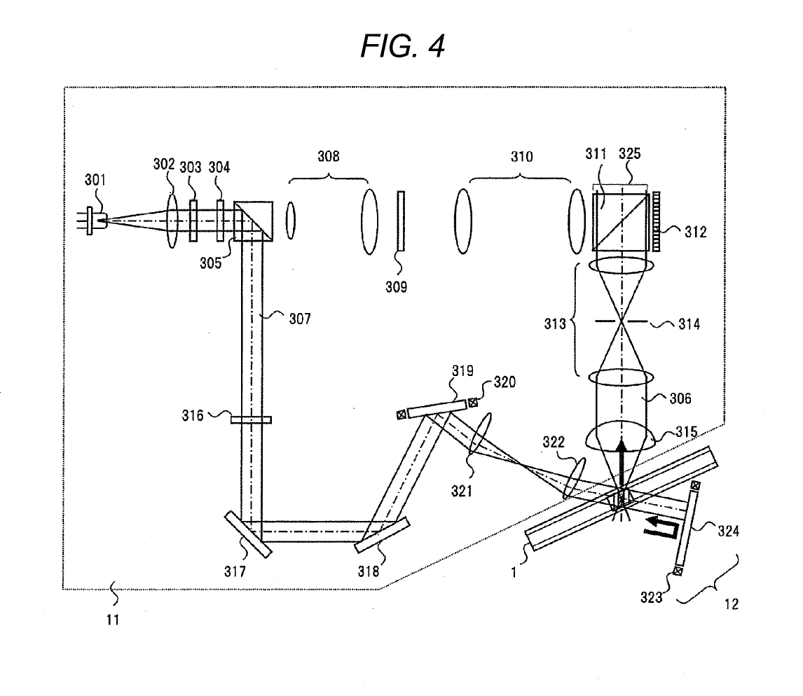

FIG. 4 illustrates a reproduction principle in an example of a basic optical system configuration of the pickup 11 in the optical information recording and reproducing apparatus 10. When the recorded information is reproduced, as described above, the reference light is input to the optical information recording medium 1, and the optical beam that has been transmitted through the optical information recording medium 1 is reflected by a galvanometer mirror 324 whose angle can be adjusted by an actuator 323, to thereby generate a reproduction reference light.

The reproduction light reproduced by the reproduction reference light propagates through the objective lens 315, the relay lens 313, and the polytopic filter 314. Thereafter, the reproduction light is transmitted through the PBS prism 311, and input to a photodetector 325, thereby being capable of reproducing the recorded signal. The photodetector 325 can be formed of an image pickup element such as a CMOS image sensor or a CCD image sensor, but may be formed of any elements if the elements can reproduce page data.

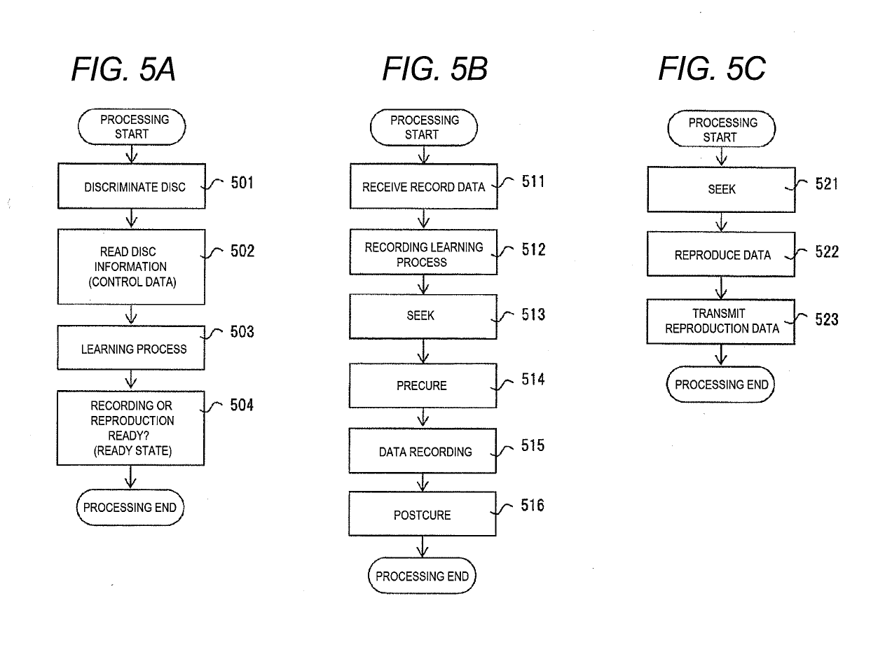

FIGS. 5A to 5C illustrate an operation flow of recording and reproduction in the optical information recording and reproducing apparatus 10. In this example, particularly, a flow of recording and reproduction using holography will be described.

FIG. 5A illustrates an operation flow from the time the optical information recording medium 1 has been inserted into the optical information recording and reproducing apparatus 10 until preparation of recording or reproduction is completed. FIG. 5B illustrates an operation flow from a ready state until information is recorded on the optical information recording medium 1. FIG. 5C illustrates an operation flow from the ready state until the information recorded on the optical information recording medium 1 is reproduced.

As illustrated in FIG. 5A, if a medium is inserted into the optical information recording and reproducing apparatus 10, the optical information recording and reproducing apparatus 10 conducts disc discrimination of whether or not, for example, the inserted medium is a medium for recording or reproducing digital information with the use of holography (502).

As a result of the disc discrimination, if it is determined that the medium is the optical information recording medium for recording or reproducing the digital information with the use of the holography, the optical information recording and reproducing apparatus 10 reads control data provided on the optical information recording medium (503), and acquires information related to, for example, the optical information recording medium, or information related to various setting conditions, for example, during recording or reproduction.

After the control data has been read, various adjustments corresponding to the control data, and a learning process (504) related to the pickup 11 are conducted, and the optical information recording and reproducing apparatus 10 completes the preparation of recording or reproduction (505).

In an operation flow from the ready state until the information is recorded, as illustrated in FIG. 5B, first, data to be recorded is received (511), and information corresponding to the data is transmitted to a spatial light modulator within the pickup 11.

Thereafter, various recording learning processes such as power optimization of the light source 301 or the optimization of an exposure time by the shutter 303 are conducted in advance as needed, so that high quality information can be recorded on the optical information recording medium (512).

Thereafter, in seek operation (513), the access control circuit 81 is controlled so that the pickup 11 and the cure optical system 13 are positioned at given positions on the optical information recording medium. If the optical information recording medium 1 has address information, the address information is reproduced, and it is confirmed whether the pickup 11 and the cure optical system 13 are positioned at intended positions, or not. If each of those components is not arranged at the intended position, a deviation amount from a given position is calculated, and the positioning operation is again repeated.

Thereafter, a given region is pre-cured (514) with the use of the optical beam emitted from the cure optical system 13, and data is recorded with the use of the reference light and the signal light emitted from the pickup 11 (515).

After the data has been recorded, a post-cure is conducted with the use of the optical beam emitted from the cure optical system 13 (516). The data may be verified as needed.

In the operation flow from the ready state until the recorded information is reproduced, as illustrated in FIG. 5C, first in the seek operation (521), the access control circuit 81 is controlled so that the pickup 11 and the reproduction reference light optical system 12 are positioned at the given positions on the optical information recording medium. If the optical information recording medium 1 has the address information, the address information is reproduced, and it is confirmed whether each of those components is positioned at the intended position, or not. If each of the components is not arranged at the intended position, a deviation amount from the given position is calculated, and the positioning operation is again repeated.

Thereafter, the reference light is emitted from the pickup 11, the information recorded on the optical information recording medium is read (522), and the reproduction data is transmitted (513).

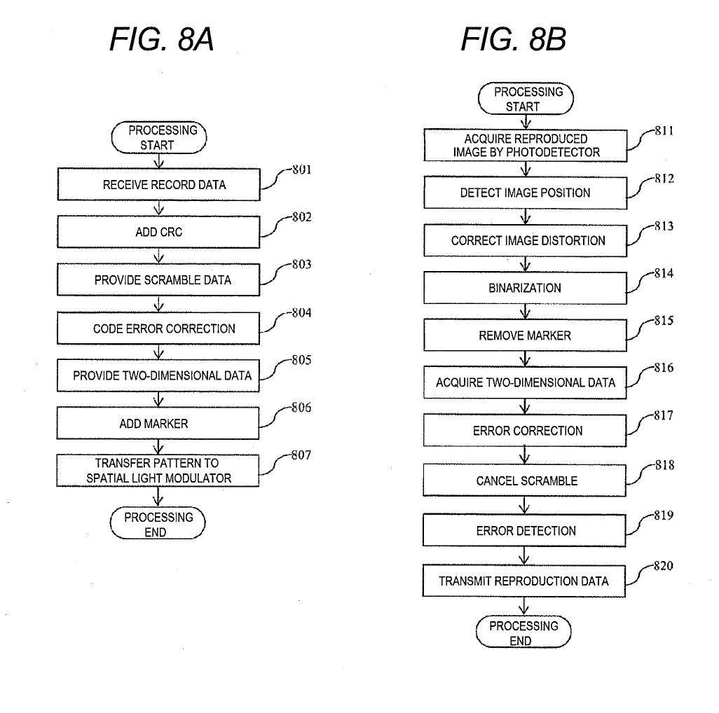

FIGS. 8A and 8B illustrate data processing flows during recording and reproduction. FIG. 8A illustrates a recording data processing flow in the signal generation circuit 86 after the recording data receiving process 511 until the recording data is converted into two-dimensional data on the spatial light modulator 312. FIG. 8B illustrates a reproducing data processing flow in the signal processing circuit 85 after the two-dimensional data has been detected in the photodetector 325 till a reproduction data transmitting process 524 in the input/output control circuit 90.

The data processing during recording will be described with reference to FIG. 8A. Upon receiving user data (801), the user data is divided into plural data sequences, and the respective data sequences are subjected to CRC (802) so that an error detection is conducted during reproduction. The number of on pixels is made substantially equal to the number of off pixels, and the data is subjected to scramble (803) in which a pseudo-random data sequence is added to the data sequence for the purpose of preventing repetition of the same pattern. Thereafter, correction coding (804) such as Reed-Solomon code is conducted so that the error correction is conducted during reproduction. Then, the data sequence is converted into two-dimensional data of M×N, and repeated for each page data to configure two-dimensional data (805) for one page. A marker which is a reference of image position detection or image distortion correction during reproduction is added (806) to the two-dimensional data thus configured. Then, the data is transferred (807) to the spatial light modulator 312.

Subsequently, a data processing flow during reproduction will be described with reference to FIG. 8B. The image data detected by the photodetector 325 is transferred (811) to the signal processing circuit 85. An image position is detected (812) on the basis of the marker included in the image data, strain such as an inclination, magnification, or distortion of the image is corrected (813). Thereafter, binarization process (814) is conducted, and the marker is removed (815) to acquire the two-dimensional data for on page (816). After the two-dimensional data thus obtained is converted into plural data sequences, an error correcting process (817) is conducted to remove a parity data sequence. Then, the data is subjected to a scramble cancel process (818), and an error detecting process (819) is conducted with the CRC to delete a CRC parity. Thereafter, the user data is transmitted (820) through the input/output control circuit 90.

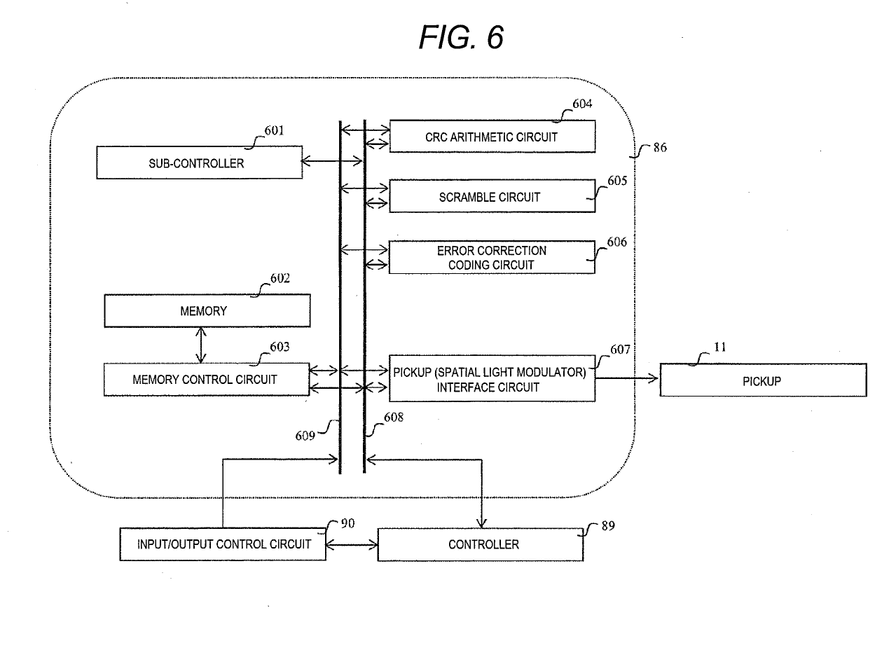

FIG. 6 is a block diagram illustrating the signal generation circuit 86 within the optical information recording and reproducing apparatus 10.

When the user data starts to be input to the input/output control circuit 90, the input/output control circuit 90 notifies the controller 89 that the input of the user data starts. Upon receiving this notification, the controller 89 instructs the signal generation circuit 86 to record data for one page which is input from the input/output control circuit 90. A sub-controller 601 within the signal generation circuit 86 is notified of the processing order from the controller 89 through a control line 608. Upon receiving this notification, the sub-controller 601 controls the respective signal processing circuits through the control line 608 so as to operate the respective signal processing circuits in parallel. First, a memory control circuit 603 is controlled to store the user data input from the input/output control circuit 90 through a data line 609 into a memory 602. If the user data stored in the memory 602 reaches a given amount, a control for subjecting the user data to CRC is conducted in a CRC arithmetic circuit 604. Then, the data subjected to CRC is subjected to scrambling in which the pseudo-random data sequence is added to the data sequence by a scramble circuit 605, and a control for conducting an error correction coding in which the parity data sequence is added to the data sequence is conducted in an error correction coding circuit 606. Finally, a pickup interface circuit 607 reads the data subjected to the error correction coding from the memory 602 in alignment order of the two-dimensional data on the spatial light modulator 312. After the marker which is the reference is added during reproduction, the two-dimensional data is transferred to the spatial light modulator 312 within the pickup 11.

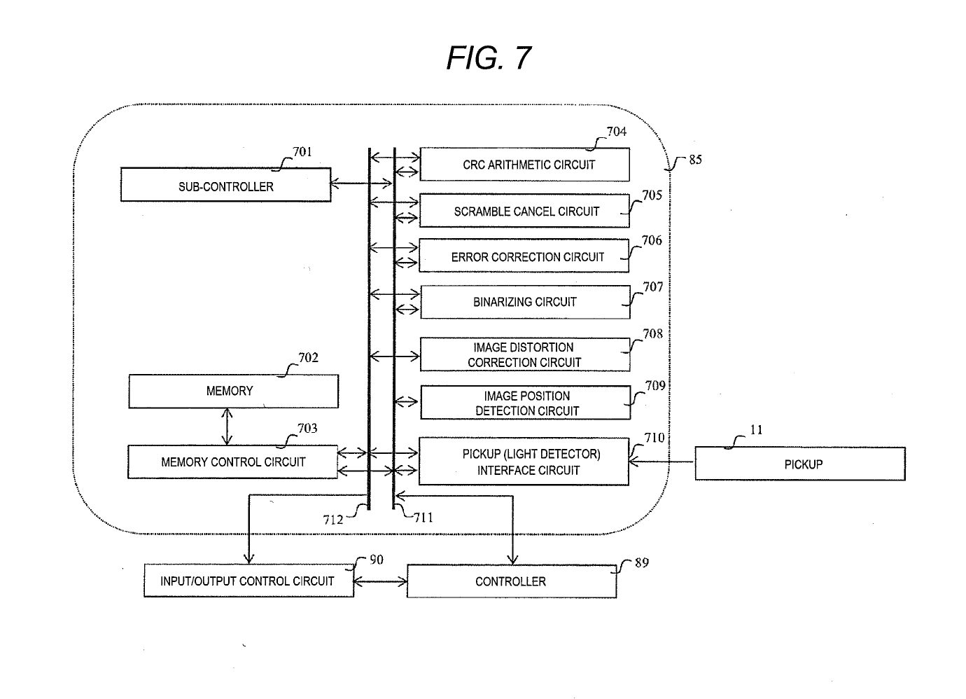

FIG. 7 is a block diagram of the signal processing circuit in the optical information recording and reproducing apparatus 10.

When the photodetector 325 within the pickup 11 detects image data, the controller 89 orders the signal processing circuit 85 to reproduce the data for one page which is input from the pickup 11. A sub-controller 701 within the signal processing circuit 85 is notifies of the processing order from the controller 89 through a control line 711. Upon receiving this notification, the sub-controller 701 controls the respective signal processing circuits through the control line 711 so as to operate the respective signal processing circuits in parallel. First, a memory control circuit 703 is controlled to store the image data input from the pickup 11 through a pickup interface circuit 710 into a memory 702 through a data line 712. If the data stored in the memory 702 reaches a given amount, the marker is detected from the image data stored in the memory 702 by an image position detector circuit 709, and a control for extracting an effective data range is conducted. Then, a strain such as an inclination, magnification, or distortion of the image is corrected on the basis of the detected marker by an image distortion correction circuit 708, and a control for converting the image data into expected sizes of the two-dimensional data is conducted. The respective bit data of the plural bits configuring the two-dimensional data converted in size is binarized for determining “0” or “1” in a binary circuit 707, and a control for storing data in output order of the reproduction data in the memory 702 is conducted. Then, errors included in the respective data sequences are corrected in an error correction circuit 706, the scramble in which the pseudo-random data sequence is added to the data sequence is cancelled in a scramble cancel circuit 705. Thereafter, a confirmation that no error is included within the user data on the memory 702 is conducted by a CRC arithmetic circuit 704. Then, the user data is transferred from the memory 702 to the input/output control circuit 90.

Now, a description will be given of a method for detecting a reproduction position deviation of the book realized by this embodiment.

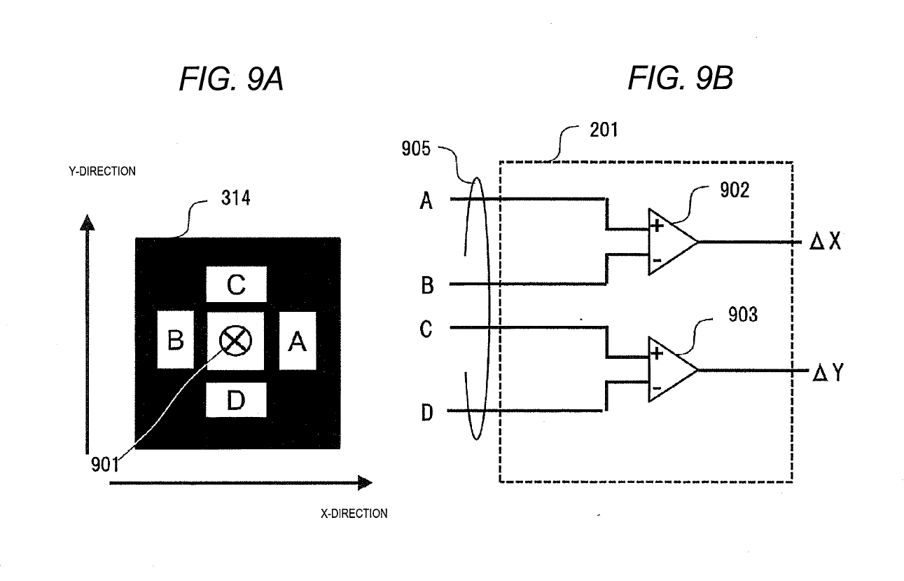

FIGS. 9A and 9B are diagrams illustrating the details of a book reproduction position deviation detecting mechanism using the polytopic filter 314. In FIGS. 9A and 9B, if the optical information recording medium is a disc, an X-direction represents a circumferential direction, and a Y-direction represents a radial direction. FIG. 9A is a diagram illustrating a light incident surface of the polytopic filter 314, in which reference numeral 901 denotes an optical axis. In FIG. 9A, symbols A to D denote photodetectors, which are arranged on the optical information recording medium side of the polytopic filter. FIG. 9B illustrates an internal configuration of a reproduction position deviation detector circuit 201 for the light input to the photodetectors A to D. Signal lines A to D indicated by reference numeral 905 are outputs of the photodetectors A to D in FIG. 9A.

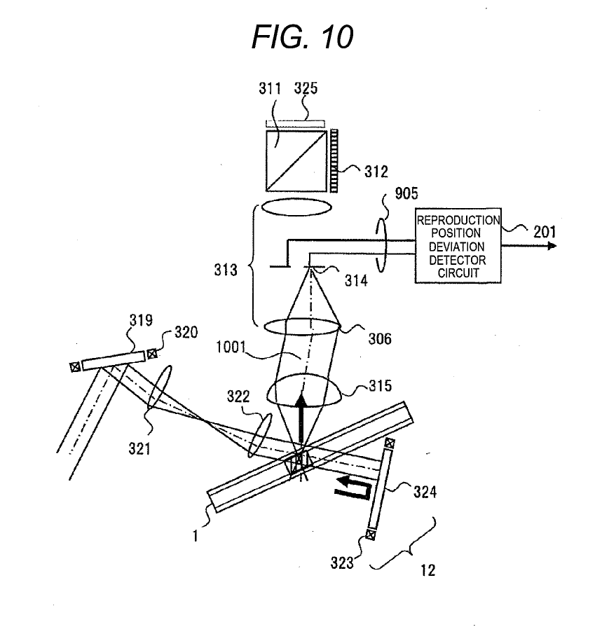

FIG. 10 is a diagram illustrating a reproduction optical system when a book reproduction position deviation is generated during reproduction. When the book reproduction position deviation is generated, a return light position 1001 is displaced as illustrated in FIG. 10, and a deviation of the light position 1001 from the opening of the polytopic filter 314 is generated. The return light 1001 that reaches the polytopic filter is detected by the photodetectors A to D on the polytopic filter illustrated in FIG. 10, and input to a reproduction position deviation detector circuit 201 through a signal line 905.

As a result, when the return light 1001 is input to the photodetector A in FIG. 9A, a positive signal of an ΔX output is output through a subtractor circuit 902 of the reproduction position deviation detector circuit 201 to detect that the position deviation occurs in a positive direction of the X-axis. Likewise, when the return light 1001 is input to the photodetector C in FIG. 9A, a positive signal of a ΔY output is output through a subtractor circuit 903 of the reproduction position deviation detector circuit 201 to detect that the position deviation occurs in a positive direction of the Y-axis. As a result, the direction of the reproduction position deviation can be detected.

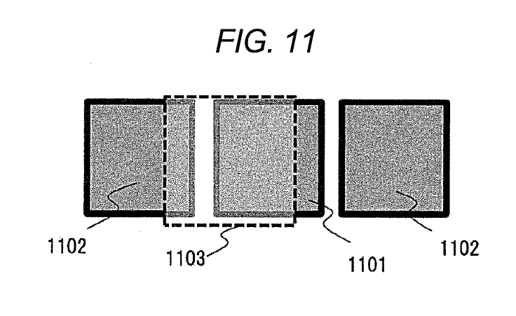

FIG. 11 is a diagram illustrating a relationship between a book recording position and a reference light irradiation position on a focal plane of the objective lens 315 when the plural books are recorded on the optical information recording medium. Reference numeral 1101 denotes a recording position of a subject book to be produced, 1102 is a recording position of an adjacent book, and 1103 a reference light irradiation position. When the page data is recorded at the same angular position in the subject book and the adjacent book, if the book and the reference light irradiation position deviate from each other as shown in FIG. 11, the reference light is applied across both of those books, the reproduction light amount is obtained from pages of both the books. For that reason, when the return light is detected by the photodetectors A to D in FIG. 9, a change in the amount of light to the reproduction position deviation is not obtained, and a reproduction position deviation detection sensitivity is not obtained.

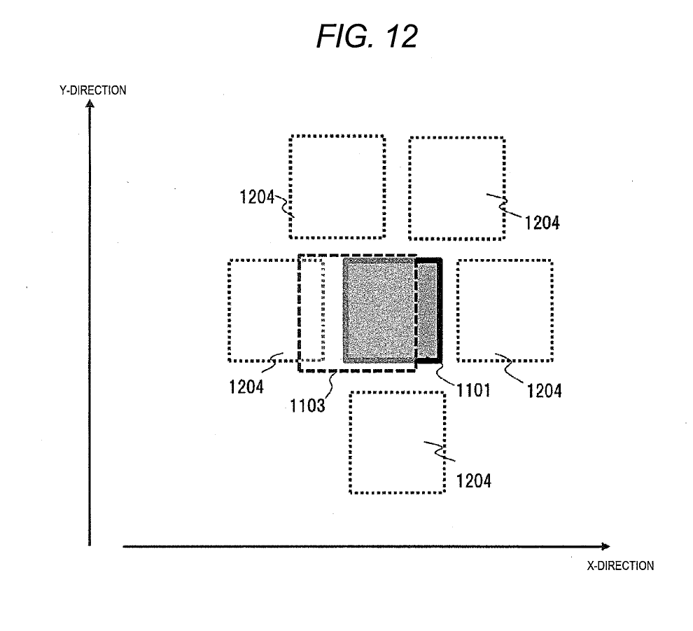

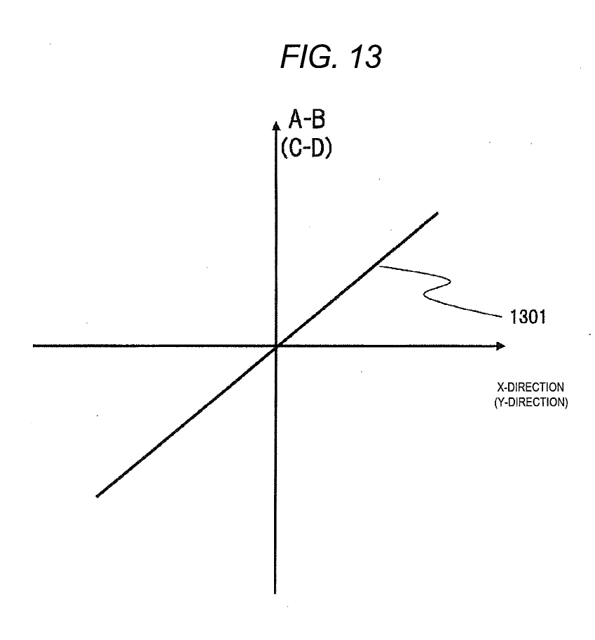

A book recording method that can detect the reproduction poSition deviation for avoiding the above drawback will be illustrated in FIG. 12. In the figure, if the optical information recording medium is a disc, an X-direction represents a circumferential direction, and a Y-direction represents a radial direction. Reference numerals 1101 and 1103 are identical with those in FIG. 11, but all of page data of the adjacent books 1204 in the X- and Y-directions are recorded at the reference light angle different from that of the data page of the book 1101. For that reason, the reproduction light amount from the adjacent books due to the position deviation between the subject book 1101 to be reproduced and the reference light 1103 is not detected, and the reproduction light amount obtained in association with the position deviation is reduced. As a result, a reproduction position deviation detection signal indicated by 1301 in FIG. 13 can be obtained from the reproduction position deviation detection signals ΔX, ΔY illustrated in FIG. 9.

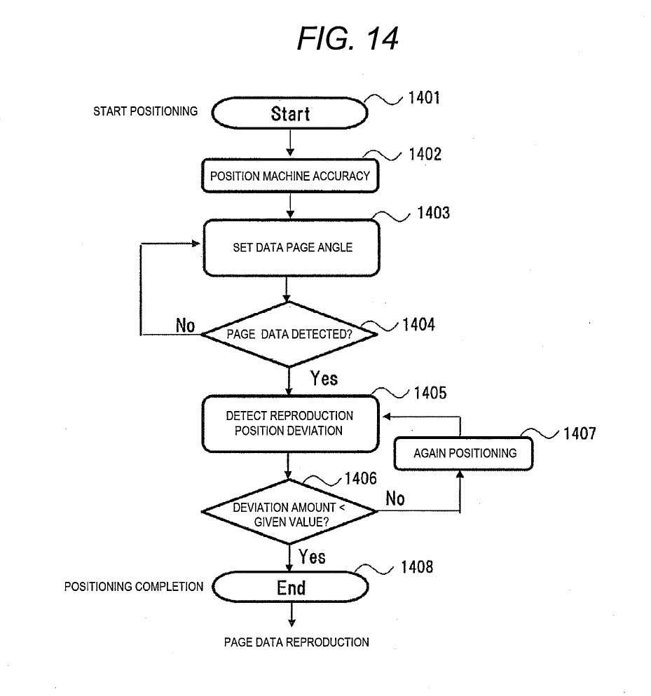

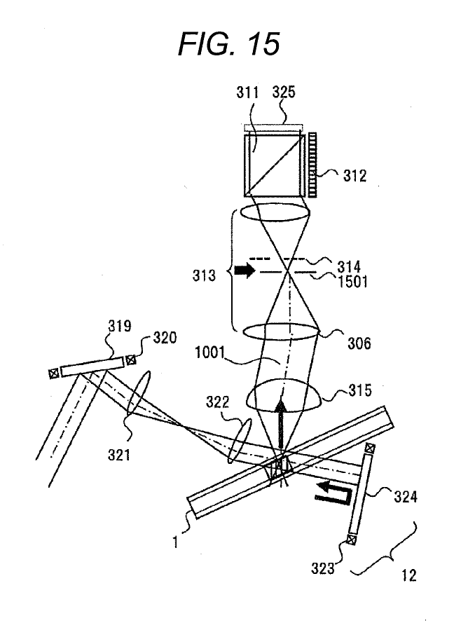

FIG. 14 illustrates an example of a sequence from book recording positioning and to data reproduction start during reproduction. Reproduction book position information is obtained by coordinate information within the information recording medium, to thereby start the book positioning (1401). First, positioning with a mechanical precision is implemented (1402). Then, the reference light angle of the data page to be reproduced in the subject book is set to reproduce the page data (1403). At this event, it is assumed that the page data becomes poor reproduction by a setting value of the reference light angle because of a recording agent within the information recording medium, for example, polymerization reaction of polymer, or contraction due to a change in temperature. Because the above-mentioned reproduction position deviation detection detects the reproduction position deviation due to a difference in the light amount reproduced from the information recording medium, it is desirable that the light amount to be reproduced is large. As a result, for example, the reference light angular position at which the light amount obtained by the page data is maximum is detected, to thereby confirm a detection completion of the page data (1404). After the page data has been detected, the reproduction position deviation detection is conducted with the use of the above-mentioned technique (1405). If the reproduction position deviation is equal to or higher than a given amount (1406), the positioning is again implemented (1407). As the re-positioning technique, for example, as illustrated in FIG. 15, when a position of the polytopic filter 314 moves in a direction indicated by an arrow in the figure, so as to reach a position of reference numeral 1501, the return light can reach the photodetector 325. The position shift amount of the polytopic filter 314 is determined on the basis of the reproduction position shift detection result. Upon completion of the positioning (1408), the reproduction of the page data starts as it is.

According to this embodiment, the stable reproduction position deviation signal can be detected with respect to the reproduction position deviation, and the reproduction position control and the page data reproduction can be conducted with a high precision.

The photodetectors A to D illustrated in FIG. 9A are arranged on the polytopic filter 314 in this embodiment. However, the photodetectors do not need to be placed on the polytopic filter 314, but may be optically flush with the polytopic filter 314. For example, a beam splitter may be arranged between the objective lens 315 and the polytopic filter 314 so that a part of the reproduction light is split by the beam splitter, and the split light is condensed by a lens, and the photodetectors may be arranged on a focal plane of the lens. The method of detecting the reproduction position deviation signal is not limited to the above detecting method.

As a configuration of eliminating the reproduction position deviation, an example in which the position of the polytopic filter 314 moves has been described. However, the present invention is not limited to this configuration, but a configuration in which the optical information recording medium or the pickup moves may be applied. The configuration for driving the polytopic filter 314 enables higher-speed reproduction. Also, the polytopic filter may be replaced with an angle filter. The angle filter represents a filter having an angle characteristic that allows the transmission of only a light input at a given angle. The angle characteristic of the angle filter is such designed that a diffracted light of the hologram to be reproduced is transmitted through the angle filter. In this situation, the diffracted light of an adjacent hologram which is input to the angle filter at an angle different from the design angle is not transmitted through the filter. Therefore, this filter can remove crosstalk from the adjacent hologram as in the polytopic filter.

### Second Embodiment

In the first embodiment, the reference light angle at which the page data of the subject book to be reproduced is recorded is different from the recording angles of the page data of all the adjacent books, to thereby enable reproduction position deviation to be detected. However, when the angle separation is implemented on the page data of all the adjacent books so as not to generate crosstalk, the angles allocated to the page data of the adjacent books cannot be used for recording the page data of the subject book. Therefore, the page data recordable angles within the books are reduced, and the number of multiplexing within the book is reduced to decrease the recording capacity.

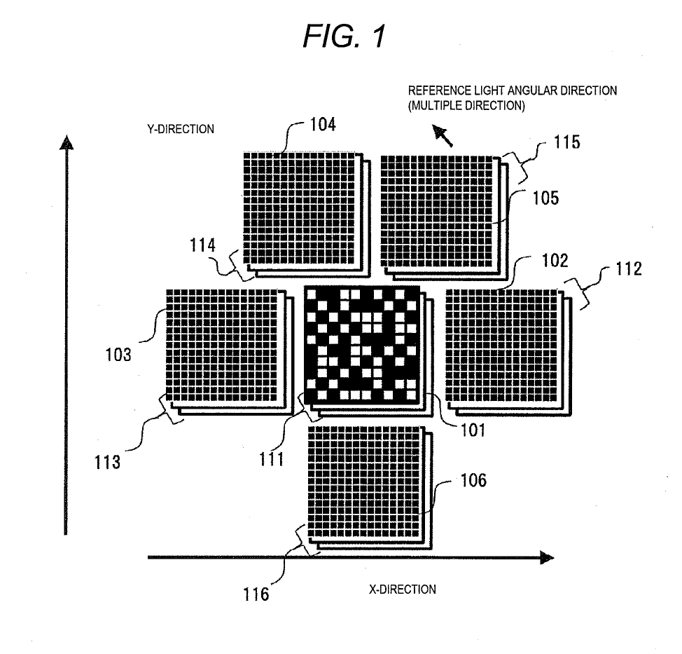

In order to solve the above problem, in the second embodiment of the present invention, page data (hereinafter called “servo page”) for detecting the reproduction position deviation is provided. FIG. 1 illustrates a relationship between the page data of the subject book and the page data of the adjacent books in the reference light angle for recording the servo page of the subject book to be reproduced. In the figure, if the optical information recording medium is a disc, an X-direction represents a circumferential direction, and a Y-direction represents a radial direction. In the figure, reference numeral 111 represents the subject book to be reproduced, and 101 represents servo page data of the subject book. It is assumed that a recording reference light angle of the servo page is θs. Reference numerals 112 to 115 denote adjacent books, 102 to 105 represent page data of the reference light angle θs. It is assumed that all of page data 102 to 105 are page data (hereinafter called “black page”) having brightness of zero. As methods of realizing the black page, there are conceivable various techniques of recording as zero data (all pixels are zero data) in the spatial light modulator, of not implementing the recording operation at the reference light angle in recording the book, and of recording the books except for the reference light angle. If the book is recorded as the zero data (all pixels are zero data) in the spatial light modulator, recording can be conducted in the same sequence as that in other books, and a recording strategy is easily set.

The servo page may be configured by a known fixed pattern, or may be configured by a pattern having a brightness of a given value or higher. Also, information indicative of the servo page may be recorded in header information or the like of a page, or those information may be combined together.

Also, the servo page may be used for not only detection of the reproduction position deviation, but also, for example, adjustment of the reference light angle, or adjustment of a laser wavelength of the light source 301. Also, the user data may be recorded, or may not be recorded on a part of the servo page.

Also, the servo page may be recorded on plural pages for one book. With this configuration, the reproduction position deviation can be more stably detected.

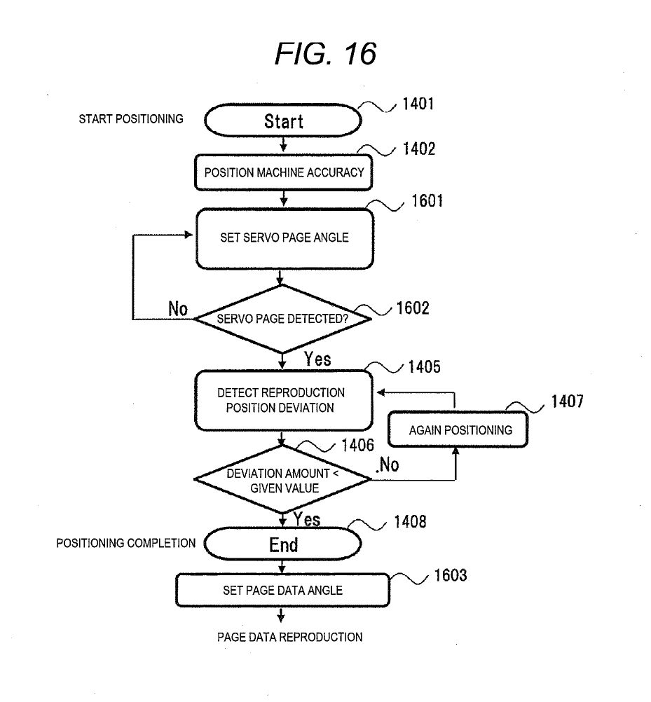

FIG. 16 illustrates an example of the book recording positioning sequence during reproduction using the servo page. The same processing as that in FIG. 14 is indicated by the same symbols, and a description thereof will be omitted.

In this embodiment, after positioning with a mechanical precision has been implemented (1402), the reference light angle at which the servo page of the subject book to be next reproduced is recorded is set (1601), and the servo page is detected (1602). A method of detecting the servo page is, for example, as in the first embodiment, to detect the reference light angular position at which the light amount obtained from the servo page is maximum to confirm the detection completion. After the servo page has been detected, the reproduction position deviation is detected through the above technique (1405). If the reproduction position deviation is equal to or higher than a given amount (1406), positioning is again implemented (1407). The re-positioning technique is, for example, the same technique as that in the first embodiment. Upon completion of the positioning (1408), the reference light angle of the data page to be reproduced is set (1603), and reproduction of the page data starts.

As in this embodiment, the page of the characteristic within the book is positioned as the servo page for reproduction positioning. As a result, as in the first embodiment, there is no need to shift the reference light angular position of the data page between the adjacent books, and the number of page data multiplexing within the book can increase, that is, the capacity of the information recording medium can increase while ensuring the book position control and the stability of the page data reproduction as in the first embodiment.

In the description of FIG. 1, the page data of the subject book and the page data of the adjacent book are recorded by the same reference angle. However, this includes not only the recording at the same reference light angle, but also the page data recorded while the reference light angle is controlled with the same angle as a control target, and the page data of the same page in the books multiplexed by controlling the reference light angle so as to be recorded at the same angular interval on the basis of the same angle.

### Third Embodiment

In the second embodiment, the positioning by the servo page has been described. In this embodiment, a reference light angle arrangement of the servo page will be described.

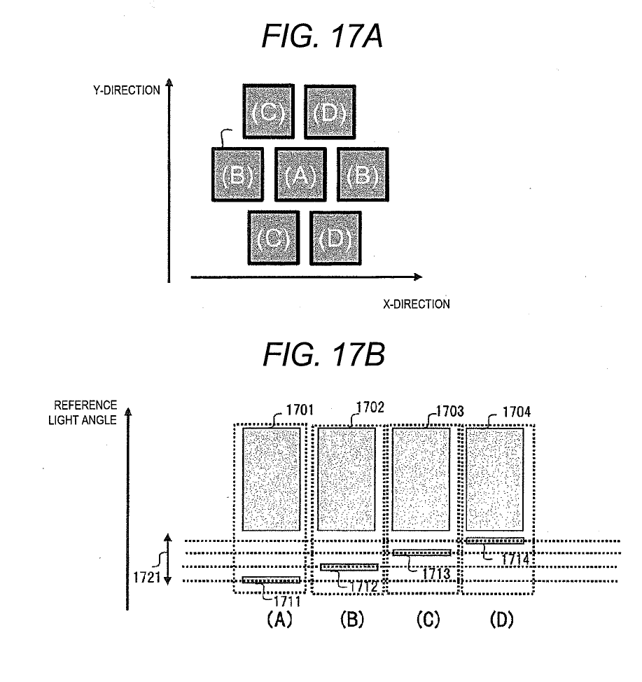

FIGS. 17A and 17B are diagrams illustrating recording reference light angles of the servo page, and the book arrangement on the information recording medium. In the figures, if the optical information recording medium is a disc, an X-direction represents a circumferential direction, and a Y-direction represents a radial direction. FIG. 17A represents a book arrangement on the information recording medium in which (A) to (D) represent the recording positions of the books. FIG. 17B represents the reference light angle arrangements of the data pages and the servo pages within the books (A) to (D). Reference numerals 1714 to 1704 denote reference light angle arrangements of the data pages on which the user data are recorded, and 1711 to 1714 denote the reference light angle arrangements of the servo pages. The servo pages are arranged in a region 1721 on the lower angle side, and the reference light angles of the servo pages of the adjacent books are shifted from each other. Each of the servo pages 1711 to 1714 may include plural pages. With this arrangement, the reproduction position deviation can be more stably detected. The data pages on which the user data is recorded are recorded in the adjacent books, and at the same reference light angle, but the reference light angles may be shifted. If the reference light angle positions and the intervals of the data pages on which the user data are recorded are made identical with those in the adjacent books, there is no need to consider the angle deviation for inserting the pages of the adjacent books, and the angular intervals of the user data can be reduced to improve the recording density.

In this embodiment, the angle arrangements of the servo pages are intensively arranged in a region 1721 of the lower angle side. When the arrangement angle regions of the servo pages are concentrated, the angular position detection of the servo page at the time of moving the book can be facilitated, and a reduction in the positioning time during the reproduction, and an improvement in the transfer rate of the reproduction data can be realized.

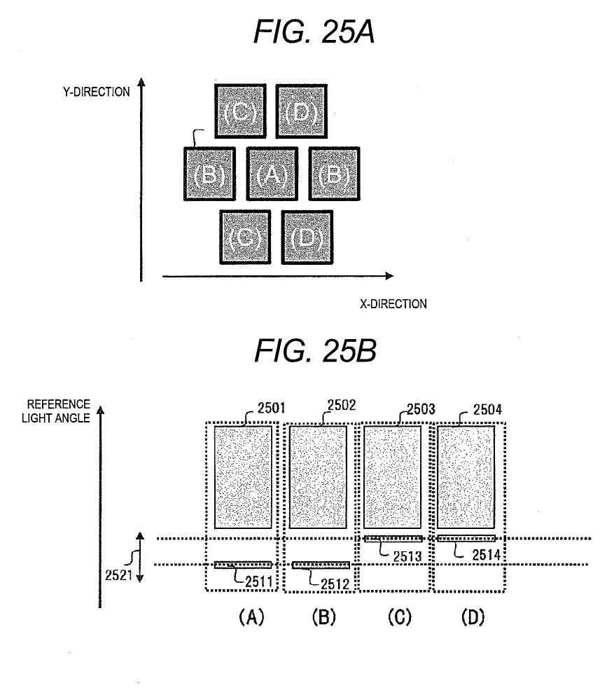

Also as illustrated in FIG. 25 the servo pages may be recorded at the same reference light angle in the circumferential direction, and may be recorded with deviation in the radial direction. The servo pages 2511 and 2512 of the books (A) and (B) adjacent to each other in the circumferential direction are recorded at the same reference light angle, and the servo pages 2513 and 2514 of the books (C) and (D) adjacent to each other in the circumferential direction are recorded at the same reference light angle. The servo pages 2511 and 2513 of the books (A) and (C) adjacent to each other in the radial direction are recorded at the different reference light angles. It is possible that the servo pages of the books adjacent to each other in the circumferential direction is recorded at the different reference light angles, and the servo pages of the books adjacent to each other in the radial direction is recorded at the same reference light angle.

### Fourth Embodiment

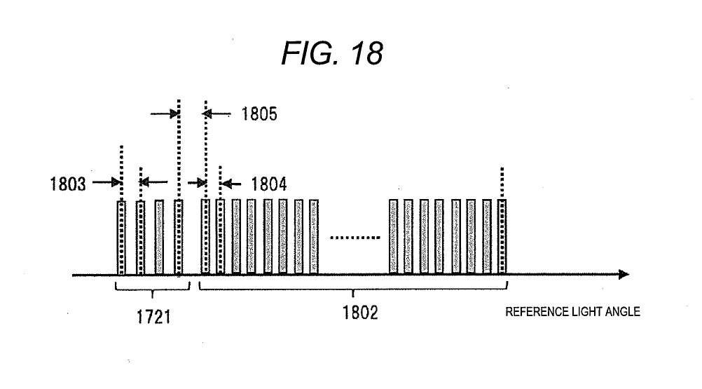

In this embodiment, the recording reference light region of the servo page region and the data page according to the third embodiment will be described with reference to FIG. 18.

Reference numeral 1721 in FIG. 18 represents the above-mentioned servo page angle region, and 1802 is a data page angle region in which the user data is recorded. In this embodiment, an angular interval 1803 of the servo page and an angular interval 1804 of the data page are so arranged as to satisfy the following relationship.

Angular interval 1803>angular interval 1804

As a result, an angular separation when detecting the servo page is improved, the reproduction book position detection sensitivity can be prevented from being deteriorated by crosstalk from the adjacent books, and as compared with the third embodiment, the more stable reproduction book position control can be improved.

The angular interval 1805 between the servo page and the data page satisfies the following relationship to obtain the same advantages.

Angular interval 1805>angular interval 1804

The recording reference light angular intervals of the above servo pages may be different between the respective servo pages, and the present invention is not limited to the details of this embodiment.

### Fifth Embodiment

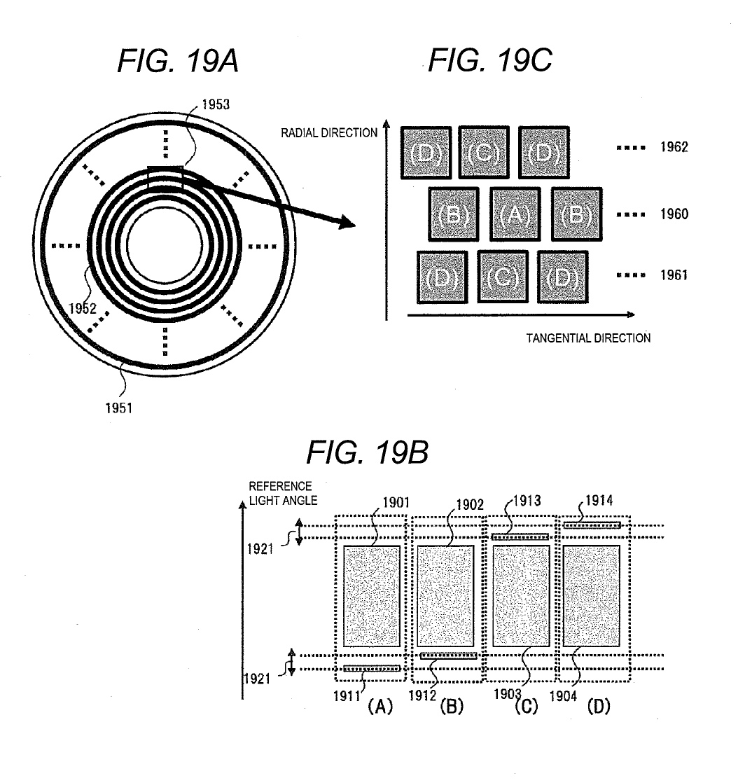

In this embodiment, a different servo page region arrangement different from that in the third embodiment will be described with reference to FIGS. 19A to 19C.

FIG. 19C illustrates a book arrangement example when recording the books on a disc information recording medium, and the books are arranged on tracks typically indicated by reference numerals 1951 and 1952.

A diagram enlarging the region 1953 in FIG. 19C is illustrated in FIG. 19A. A position relationship of the books (c) and (D) on tracks 1961 and 1962 on both sides of a central track 1960 with respect to the books (A) and (B) on the central track 1960 are different on an inner peripheral side and an outer peripheral side because circumferential lengths of the tracks are different from each other. Therefore, there is a need to surely make the recording reference light angular positions between the servo pages of books (A), (B), and the books (C), (D) different from each other. Also, when the medium is held in the center of the disc, because a disc warp is generated toward the radial direction, if the reference light angular positions of the books (A), (B), and the books (C), (D) on both sides thereof come closer to each other, even if the recording reference light angle of the servo pages is set to a different angular position, there is a risk that a desired angular interval cannot be ensured within the medium.

Under the circumstances, as illustrated in FIG. 19B, the positions of the recording reference light angles of the servo pages between the tracks adjacent to each other are distributed to a lower angle side and a higher angle side in the angle multiplexing range of the data page. In this embodiment, the servo pages of the track 1960 are arranged on the lower angle side, and the servo pages of the adjacent tracks 1961 and 1962 are recorded on the higher angle side. In the books (A) and (B) arranged on the track 1960, servo pages 1911 and 1912 are arranged on the lower angle side than the data pages 1901 and 1902 on which the user data are recorded, and in the books (C) and (D) arranged on the tracks 1961 and 1962, servo pages 1913 and 1914 are arranged on the higher angle side than the data pages 1903 and 1904 on which the user data are recorded.

As a result, the stable detection of the servo pages, and the reproduction book position control caused by the stable detection can be realized regardless of the inclination of the information recording medium, and the positional relationship of the adjacent books.

Also, in this embodiment, the angular arrangement of the servo pages in the track direction of the information recording medium on the disc is separated to the lower angle side and the higher angle side. However, the shape of the information recording medium, and the method of separating the angular arrangement to the lower angle side and the higher angle side are not limited to this embodiment.

### Sixth Embodiment

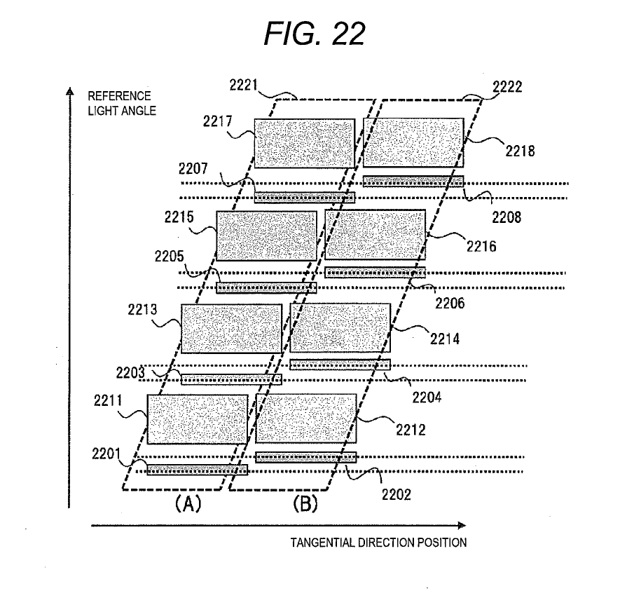

In recording the information on the information recording medium by the holography, in order to avoid the concentration of the exposure energy of recording, there is a method of recording the information by shifting the position while overlapping with the recording positions of the books (hereinafter called “short stack recording”). In a sixth embodiment of the present invention, the servo page arrangement corresponding to the short stack recording will be described with reference to FIG. 22. This embodiment shows an example in which in recording the books on the disc information recording medium, the short stacks are divided into four angular regions in a tangential direction. Also, the adjacent books of the book to be reproduced are typically represented by the adjacent books in the tangential direction.

In the figure, reference numeral 2221 denotes the subject reproduction book, and the data page that records the user data of the subject book is recorded in four stacks of 2211, 2213, 2215, and 2217, separately, whose angular regions are changed while the recording regions are shifted by ¼ book size for every stack in the tangential direction. In this situation, the servo pages used for position control of the stack 2211 is arranged in the vicinity 2201 of the angular region of the stack 2211. Likewise, the servo pages used for position control of the stacks 2213, 2215, and 2217 are arranged in the vicinity 2203, 2205, and 2207 of the same angular regions.

Likewise, reference numeral 2222 denotes a book adjacent to the book 2221 in the tangential direction, and is recorded in four stacks of 2212, 2214, 2216, and 2218, separately, as with the book 2221. In the arrangement of the servo pages, as with the book 2221, the servo page is recorded in the vicinity 2202, 2204, 2206, and 2208 of the angular regions 2212, 2214, 2216, and 2218 of the respective stacks.

With the configuration of this embodiment, even when the short stack is applied, the same advantages as those in the second embodiment of the present invention can be obtained.

### Seventh Embodiment

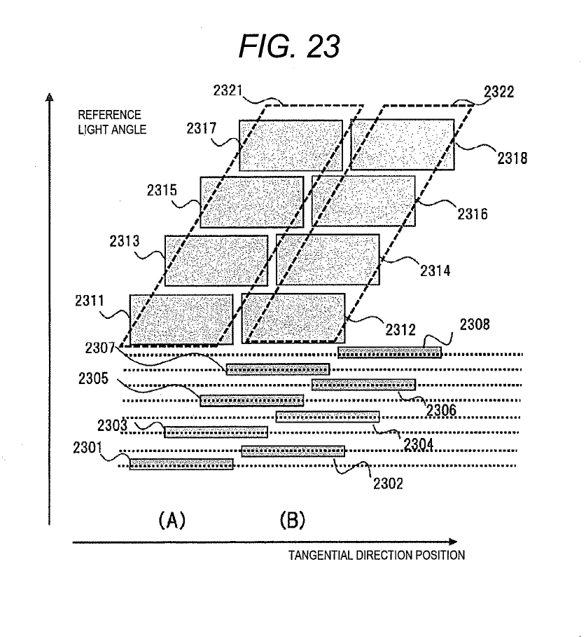

In a seventh embodiment of the present invention, an embodiment different from the sixth embodiment of the servo page arrangement corresponding to the short stack recording will be described with reference to FIG. 23. The medium shape and the adjacent conditions in this embodiment are identical with those in the sixth embodiment.

In the figure, reference numeral 2321 denotes the subject reproduction book, and the data page that records the user data of this book is recorded in four stacks of 2311, 2313, 2315, and 2317, separately, whose angular regions are changed by shifting the recording region by ¼ book size for every stack in the tangential direction. The servo pages of 2301, 2303, 2305, and 2307 of the respective stacks are intensively arranged on the lower angle side of the stack 2311.

Likewise, reference numeral 2322 denotes a book adjacent to the book 2321 in the tangential direction, and is recorded in four stacks of 2312, 2314, 2316, and 2318, separately, as with the book 2321. In the arrangement of the servo pages, as with the book 2321, the servo pages 2302, 2304, 2306, and 2308 of the respective stacks are recorded on the lower angle side of the stack 2312 at angles different from those of the servo pages 2301, 2303, 2305, and 2307, as with the book 2331.

With the above configuration of this embodiment, even when the short stack is applied, the same advantages as those in the third embodiment of the present invention can be obtained.

In this embodiment, the servo pages are arranged on the lower angle side of the corresponding stacks. Alternatively, the servo pages may be arranged on the higher angle side of the stacks, and the relationship of the servo pages and the angular positions of the stacks are not limited to the above examples. Also, the stacks having the conditions in which the relationship between the servo pages and the stacks is different may be present within the same book, and the page data must be recorded at the same recording angle of the adjacent books.

### Eight Embodiment

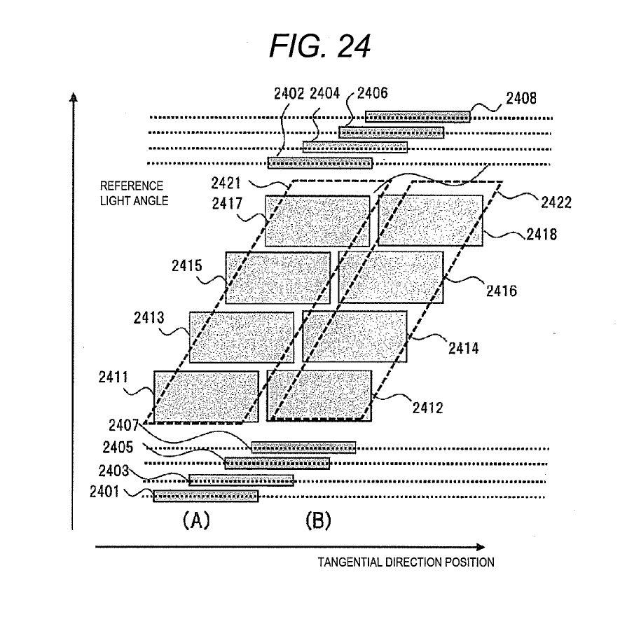

In an eighth embodiment of the present invention, an embodiment different from the sixth and seventh embodiments of the servo page arrangement corresponding to the short stack recording will be described with reference to FIG. 24. The medium shape and the adjacent condition in this embodiment are identical with those in the sixth embodiment.

In the figure, reference numeral 2421 denotes the subject reproduction book, and the data page that records the user data of this book is recorded in four stacks of 2411, 2413, 2415, and 2417, separately, whose angular regions are changed by shifting the recording regions by ¼ book size for every stack in the tangential direction. The servo pages of 2401, 2403, 2405, and 2407 of the respective stacks are intensively arranged on the lower angle side of the stack 2411.

Likewise, reference numeral 2422 denotes a book adjacent to the book 2421 in the tangential direction, and is recorded in four stacks of 2412, 2414, 2416, and 2418, separately, as with the book 2421. In the arrangement of the servo pages, in order to avoid an interference with the servo page of the book 2321, the servo pages 2302, 2304, 2306, and 2308 of the respective stacks are recorded on the higher angle side of the stack 2418.

With the above configuration of this embodiment, even when the short stack is applied, the same advantages as those in the fourth embodiment of the present invention can be obtained.

The positions of the adjacent books and the servo pages in the third embodiment to the eighth embodiment are not limited to the details described in the embodiments.

Also, in the second embodiment to the eighth embodiment, the medium shape is disc-shaped, and the adjacent book position conditions are described at the adjacent position in the tangential direction, or the adjacent position in the tangential and radial directions. However, in the angular multiplexing recording medium using the holograph in which the plural books are adjacently recorded, the embodiments are entirely applicable, and are not limited to the above recording medium shapes, and the adjacent book position conditions.

### Ninth Embodiment

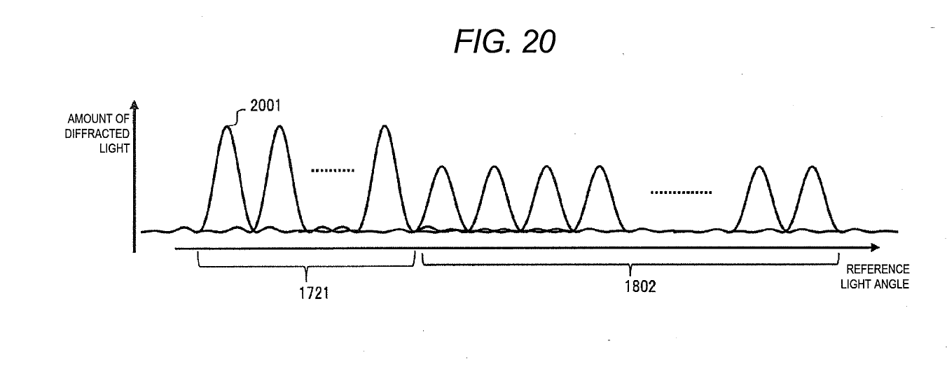

A ninth embodiment of the present invention will be described with reference to FIG. 20. In FIG. 20, the same parts as those in FIG. 18 are denoted by identical reference numerals.

A mountain shape typified by reference numeral 2001 in the figure is called “angle selectivity” or “brag selectivity”, and shows a reference light angle dependency of the diffracted light amount obtained by the reference light irradiation when reproducing the page data. As widths of the mountains of the angle selectivity are thinner, the leakage into the page data recorded at the adjacent reference angle, so-called crosstalk is reduced, and the number of angular multiplexing can be increased. On the other hand, as the mountains of the degree selectivity is higher in level, the obtained diffracted light amount increases, and the SNR (signal noise ratio) becomes excellent. However, the consumption of a monomer forming the holograph in the recording medium increases, and the number of recording multiplexing is decreased.

In this embodiment, the information is recorded so that the diffracted light amount obtained in the angular region 1721 of the servo page is larger than the diffracted light amount obtained in the data page angular region 1802 recording the user data. Specifically, for example, a power of the laser of the light source and/or the irradiation time can be increased to increase the diffracted light amount. As a result, the detection SNR of the servo pages can be improved, and the stable reproduction book position control can be realized. Because the number of servo pages is sufficiently smaller than the number of data pages, an influence on a reduction in the number of recording multiplexing is slight.

### Tenth Embodiment

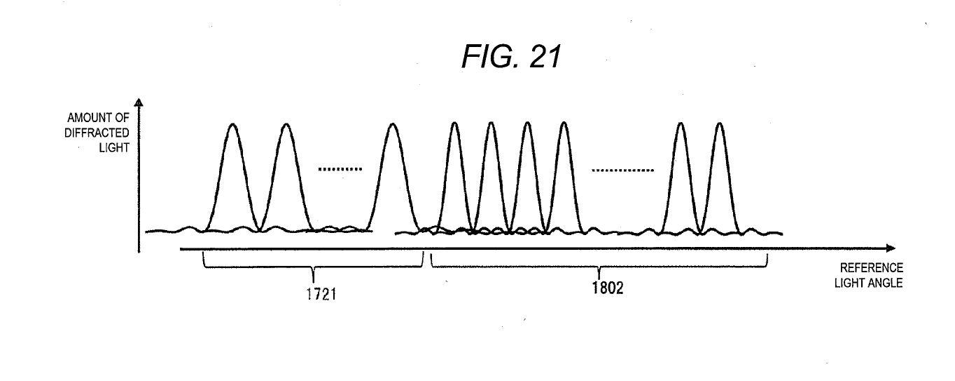

A tenth embodiment of the present invention will be described with reference to FIG. 21. In FIG. 21, the same parts as those in FIG. 20 are denoted by identical reference numerals.

In this embodiment, information is recorded so that a range of the angle selectivity of an angular region 1721 of the servo pages is larger than a range of the angle selectivity obtained in a data page angular region 1802 recording the user data. As a result, the detection of the servo page when the setting of the reference light angle is shifted is facilitated, and the stable reproduction book position control can be realized. As a method of increasing the range of the angle selectivity of the servo page, for example, the recording wavelength is increased. There is conceivable a method of artificially increasing the range of the angle selectivity by recording the same page data plural times at narrow angular intervals.

The present invention is not limited to the above embodiments, but includes various modified examples. For example, in the above-mentioned embodiments, in order to easily understand the present invention, the specific configurations are described. However, the present invention does not always provide with all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

Also, the control lines and the information lines necessary for description are illustrated, and all of the control lines and the information lines necessary for products are not illustrated. In fact, it may be conceivable that most of the configurations are connected to each other.

What is claimed is:

1. An optical information reproducing apparatus for reproducing information from an optical information recording medium, the apparatus comprising:
a light source that emits a reference light;
an angle adjustment part that adjusts an incident angle of the reference light emitted from the light source to the optical information recording medium;
a filter part that suppresses an unnecessary light of a diffracted light obtained when the optical information recording medium is irradiated with the reference light adjusted by the angle adjustment part;
a light detection part that detects at least a part of the diffracted light obtained by irradiating the optical information recording medium with the reference light adjusted by the angle adjustment part; and
a control part that controls the filter part,
wherein at least a part of page data within an adjacent book is recorded as information on the optical information recording medium while deviating the incident angle of the reference light in an angle multiplexing direction, and
wherein the control part controls the filter part on the basis of the signal detected by the light detection part.

2. The optical information reproducing apparatus according to claim 1,
wherein the light detection part detects a relative position deviation amount between an irradiation position of the reference light and a recording position of a target reproduction book, and
wherein the control part controls the filter part on the basis of the detected relative position deviation amount.

3. The optical information reproducing apparatus according to claim 2,
wherein the filter part is a polytopic filter, and
wherein the control part drives the polytopic filter on the basis of the detected relative position deviation amount.

4. An optical information recording method for recording information on an optical information recording medium with the use of a signal light and a reference light, the method comprising the steps of:
changing a reference light angle;
recording a first book including first page data corresponding to a first reference light angle; and
recording a second book adjacent to the first book, including second page data corresponding to a second reference light angle;
wherein the first reference light angle is different from the second reference light angle, and
wherein the first page data and the second page data are servo pages for conducting reproduction positioning on the first book and the second book, respectively.

5. The optical information recording method according to claim 4,
wherein the servo page is a known fixed pattern.

6. The optical information recording method according to claim 4,
wherein the servo page is a pattern of a given value or more.

7. An optical information recording method for recording information on an optical information recording medium with the use of a signal light and a reference light, the method comprising the steps of:
changing a reference light angle;
recording a first book including a first page data corresponding to a first reference light angle, and a second page data corresponding to a second reference light angle; and
recording a second book adjacent to the first book, including a third page data corresponding to a third reference light angle, and a fourth page data corresponding to a fourth reference light angle,
wherein the reproduction positioning is conducted on the first book with the use of the first page data and/or the second page data,
wherein the reproduction positioning is conducted on the second book with the use of the third page data and/or the fourth page data, and
wherein the first reference light angle and the second reference light angle are arranged on a higher angle side or a lower angle side of the third reference light angle and the fourth reference light angle.

8. The optical information recording method according to claim 7,
wherein the first page data and the second page data are arranged on a lower angle side of page data including user data, and
wherein the third page data and the fourth page data are arranged on a higher angle side of page data including user data,

9. The optical information recording method according to claim 8,
wherein the first book and the second book are adjacent to each other in a radial direction of the optical information recording medium.

10. An optical information recording method for recording information on an optical information recording medium with the use of a signal light and a reference light, the method comprising the steps of:
changing a reference light angle; and
recording a book including a first page data corresponding to a first reference light angle, a second page data corresponding to a second reference light angle, a third page data corresponding to a third reference light angle, and a fourth page data corresponding to a fourth reference light angle,
wherein reproduction positioning is conducted with the use of the first page data and the second page data,
wherein the third page data and the fourth page data include use data,
wherein the first reference light angle and the second reference light angle are arranged on a higher angle side or a lower angle side of the third reference light angle and the fourth reference light angle, and
wherein an angular interval between the first reference light angle and the second reference light angle is larger than an angular interval between the third reference light angle and the fourth reference light angle.

11. The optical information recording method according to claim 4,
wherein the amount of diffracted light obtained from the servo page is larger than the amount of diffracted light obtained from the page data including the user data.

12. The optical information recording method according to claim 4, further comprising the step of: recording data in which all of the page data is zero in the first angle of the second book.

13. An optical information recording method for recording information on an optical information recording medium with the use of a signal light and a reference light, the method comprising the steps of:
changing a reference light angle;
recording a first book including a first page data corresponding to a first reference light angle, and a second page data corresponding to a second reference light angle; and
recording a second book adjacent to the first book, including a third page data corresponding to a third reference light angle, and a fourth page data corresponding to a fourth reference light angle,
wherein the reproduction positioning is conducted on the first book with the use of the first page data,
wherein the reproduction positioning is conducted on the second book with the use of the third page data,
wherein the second page data and the fourth page data include user data,
wherein the first reference light angle is different from the third reference light angle, and
wherein the second reference light angle is identical with the fourth reference light angle.

14. An optical information reproducing method for reproducing information from an optical information recording medium, the method comprising the steps of:
emitting a reference light;
adjusting an incident angle of the emitted reference light to the optical information recording medium;
suppressing an unnecessary light of a diffracted light obtained when irradiating the optical information recording medium with the adjusted reference light by a filter;
detecting at least a part of the diffracted light obtained when irradiating the optical information recording medium with the adjusted reference light; and
controlling the filter,
wherein at least a part of page data within an adjacent book is recorded as information on the optical information recording medium while deviating the incident angle of the reference light in an angle multiplexing direction, and
wherein the filter is controlled on the basis of the detected signal in the control step.
